(19) United States
(12) Patent Application Publication
(10) Pub. No.: US 2026/0119289 A1
(43) Pub. Date: Apr. 30, 2026

(54) Server Support for Multiple Types of Embedded Datastores

(71) Applicant: Tinder LLC, Dallas, TX (US)

(72) Inventor: Christopher Thomas, Los Angeles, CA (US)

(21) Appl. No.: 18/931,543

(22) Filed: Oct. 30, 2024

(51) Int. Cl. G06F 9/54

(52) U.S. Cl. CPC G06F 9/547; G06F 9/542

(57) ABSTRACT

A method is to initialize a server. The method includes receiving a plurality of configurations for the server, each of the plurality of configurations defining at least an application programming interface (API); receiving an indication of a first configuration of the plurality of configurations; performing a determination of the API, at least in part based on the indication; and preparing the server for the API, at least in part based on the determination.

### BACKGROUND

### Technical Field

This disclosure relates to information retrieval and, in particular, to server support for multiple types of embedded datastores.

### Related Art

Conventionally, backend services for a smartphone application can retrieve text that has been translated from English into other languages. The services then serve one of the translated versions of this text to a user, based on the user's locale settings.

One way of reading these translated strings involves downloading and writing hundreds of thousands of files to disk each time a relevant service's container is created. When containers that require that data are initialized concurrently, heavy disk input/output results from writing so many small files. Accordingly, this writing can cause severe issues on the underlying system servers.

As an alternative solution, the files can be moved to a collection of shared storage mount points. However, these shared storage mount points are quite expensive and also have scalability and performance issues when services are redeployed.

### BRIEF SUMMARY

In a first implementation of the present disclosure, a method is to initialize a server. The method includes receiving a plurality of configurations for the server, each of the plurality of configurations defining at least an application programming interface (API); receiving an indication of a first configuration of the plurality of configurations; performing a determination of the API, at least in part based on the indication; and preparing the server for the API, at least in part based on the determination.

In a second implementation of the present disclosure, a system includes a memory that stores at least one instruction; and at least one processor configured, with the memory, to cause the system to at least receive a plurality of configurations for a server, each of the plurality of configurations defining at least an application programming interface (API); receive an indication of a first configuration of the plurality of configurations; perform a determination of the API, at least in part based on the indication; and perform a preparation of the server for the API, at least in part based on the determination.

In a third implementation of the present disclosure, a computer-readable medium is encoded with a computer program that, when executed by a system including at least one processor, causes the system to perform operations. The operations include receiving a plurality of configurations for a server, each of the plurality of configurations defining at least an application programming interface (API); receiving an indication of a first configuration of the plurality of configurations; performing a determination of the API, at least in part based on the indication; and preparing the server for the API, at least in part based on the determination.

In a fourth implementation of the present disclosure, an apparatus includes receiving means for receiving a plurality of configurations for the server, each of the plurality of configurations defining at least an application programming interface (API), and for receiving an indication of a first configuration of the plurality of configurations; and processing means for performing a determination of the API, at least in part based on the indication, and for preparing the server for the API, at least in part based on the determination.

### BRIEF DESCRIPTION OF DRAWINGS

FIG. 1 illustrates a conceptual architecture, according to an implementation of the present disclosure.

FIG. 2 illustrates a comparative design configuration.

FIG. 3 illustrates a super-configuration, according to an implementation of the present disclosure.

FIG. 4 illustrates a configuration, according to an implementation of the present disclosure.

FIG. 5 illustrates a comparative algorithm implemented by a computer and known to the present inventor.

FIG. 6 illustrates an algorithm for a computer to initialize a configuration of a server, according to an implementation of the present disclosure.

FIG. 7 illustrates an algorithm for a server to handle a database query, according to an implementation of the present disclosure.

FIG. 8 illustrates an algorithm for a server to handle a gossip request, according to an implementation of the present disclosure.

FIG. 9 illustrates a computing device, according to an implementation of the present disclosure.

### DETAILED DESCRIPTION

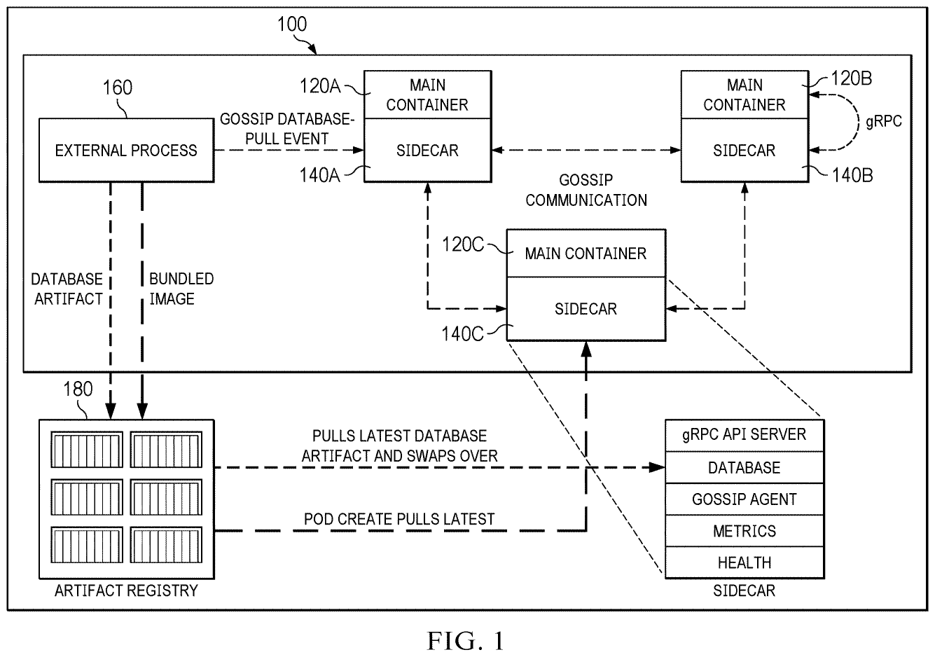

FIG. 1 illustrates a conceptual architecture 100, according to an implementation of the present disclosure. The conceptual architecture 100 can be implemented in Kubernetes, Docker, or Amazon Web Services'Elastic Kubernetes Service (EKS), for example. The conceptual architecture 100 includes a plurality of main containers 120A, 120B, 120C and a plurality of sidecars 140A, 140B, 140C, each for a different main container 120A, 120B, 120C. In addition, the conceptual architecture can include an external process 160 and an artifact registry 180.

The main containers 120A, 120B, 120C are packages of software that contain elements to run in an environment. For example, the main containers 120A, 120B, 120C can include application code, as well as programming language runtimes and libraries. The sidecars 140A, 140B, 140C are secondary containers that run alongside the main containers 120A, 120B, 120C. As illustrated in FIG. 1, the sidecar 140A runs alongside the main container 120A, the sidecar 140B runs alongside the main container 120B, and the sidecar 140C runs alongside the main container 120C. Thus, an embedded datastore can advantageously be served as a queryable (read-only) cache within a co-Located application.

In particular, the sidecar can run alongside a backend application that uses data close to the source without reading from a central store in real-time. In particular implementations, a copy of the data can be distributed to each of sidecars 140A, 140B, 140C, and thus, each main container that uses the data. This distribution can result in extremely fast lookup times, as well as the data not being served from a single point of failure.

Many implementations of the present disclosure can be implemented in the sidecars 140A, 140B, 140C. Although not illustrated in FIG. 1, implementations of the present disclosure can also include a server and/or an application.

Each of the sidecars 140A, 140B, 140C can include a gRPC (Google Remote Procedure Call) application programming interface (API) server, a database, a gossip agent, metrics, and health.

The main containers 120A, 120B, 120C can communicate with their respective sidecars 140A, 140B, 140C via gRPC. Accordingly, in addition to providing a pluggable backend for a database technology (or flat file) to plug into, an interface to serve an API via gRPC can be provided.

As illustrated in FIG. 1, the sidecars 140A, 140B, 140C can communicate with each other via a peer-to-peer Gossip protocol to form a decentralized cluster. Thus, select implementations of the present disclosure can include a notification layer for update triggers to propagate across the sidecar pods. In various implementations, notifications to pull new datastore versions can be relayed to clients rather than them polling or watching a centralized service for changes. Therefore, consistency for data updates can be achieved.

The external process 160 can update the data artifact and image. For example, when a new artifact is ready for consumption, the external process 160, which has joined the cluster, can send a Gossip database-pull event. When a member (e.g., sidecar 140A) receives the event, the member can propagate the event to other members via the Gossip protocol. Then, the member can pull the new data artifact version provided in the event from the artifact registry 180 and swap it transparently in the backend.

The external process 160 can transmit a database artifact and a bundled image to the artifact registry 180. In addition, the external process 160 can provide a Gossip database-pull event to the sidecar 140A.

The artifact registry 180 stores data artifacts. In various implementations, the data artifacts can comply with the Open Container Initiative (OCI). This storage provides a transparent way of versioning and storing the data while providing a clean and extensible interface to interact with the files.

The sidecars 140A, 140B, 140C can pull the latest database artifact from the artifact registry 180 and swap over. Thus, this separate pipeline can handle modifications to the datastore and send a message to the cluster. The sidecars 140A, 140B, 140C can be informed that there is a new datastore version for them to download and hot-swap.

The base image in the artifact registry 180 can have the artifact embedded within it as a layer. Then, a pod create can pull the latest database from the artifact registry 180. Accordingly, applications initialized after the latest container image and artifact are pushed to their respective repositories can already have the latest data. Thus, some implementations of this pipeline can ensure that new instances that start already have the latest data in their initial image.

Further, because each sidecar can be initialized with different databases or APIs, the architecture can allow multiple databases and/or APIs to be served concurrently. In addition, each sidecar can be localized to each application, potentially avoiding a shared service/infrastructure.

In testing, the sidecars were found to be highly available and performant. In particular, in various implementations, a local copy of data can be made available to an instance with very little overhead and long-term cost. This availability can be achieved by (a) bundling the data inside an embedded key-value database within the sidecar container image, (b) using a Gossip protocol to notify cluster members of new datastore artifacts, and/or (c) providing a language-agnostic gRPC API to interact with the embedded database server.

Various implementations can advantageously provide redundancy. For example, if an issue were to arise, existing data could remain servable by any application that already has that data. Indeed, only new versions of the data would not propagate until the degradation has been resolved.

In assorted implementations, a server component according to the present disclosure can have a completely pluggable backend. The pluggable nature allows for downloading files/artifacts to a specified location on the filesystem and/or embedding a database server alongside the gRPC API that serves it.

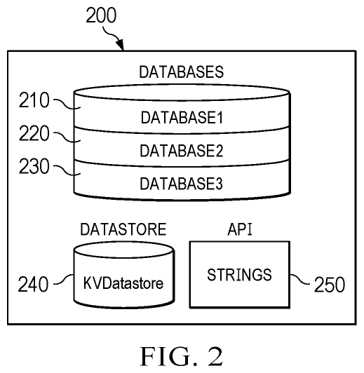

FIG. 2 illustrates a comparative design configuration 200 known to the present inventor. As shown in FIG. 2, the comparative design configuration 200 includes a plurality of databases 210, 220, 230, a datastore 240, and an API 250. In an implementation of FIG. 2, the name of the database 210 is “Database1,” the name of the database 220 is “Database2,” and the name of the database 230 is “Database3.”

As illustrated in FIG. 2, the comparative design configuration 200 has a single server configuration in which the datastore 240 and the API 250 are predetermined. The name of the datastore 240 is “KVDatastore,” and the name of the API 250 is “Strings.”

Because the comparative design configuration 200 supports only one configuration, a resource (such as a database) can be initialized by name only.

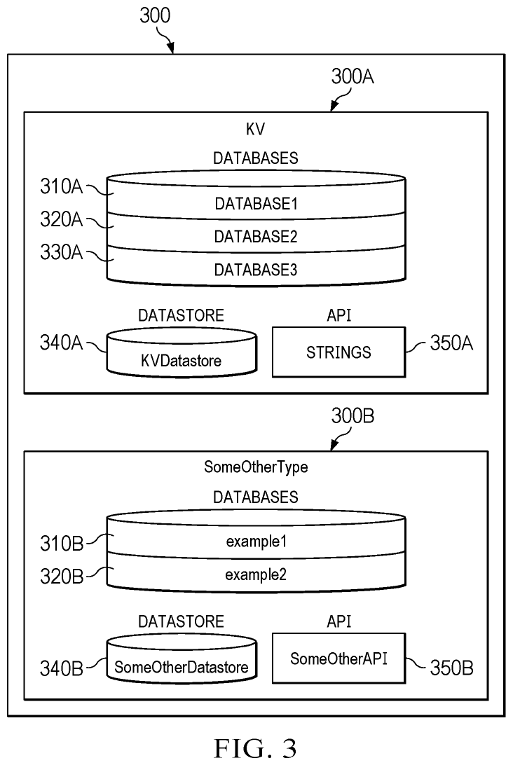

FIG. 3 illustrates a super-configuration 300, according to an implementation of the present disclosure. The super-configuration 300 includes two configurations, 300A and 300B.

The configuration 300A is similar to the comparative design configuration 200 of FIG. 2. For example, the configuration 300A includes a plurality of databases 310A, 320A, 330A, a datastore 340A, and an API 350A. The name of the database 310A is “Database1,” the name of the database 320A is “Database2,” and the name of the database 330A is “Database3.” Further, the name of the datastore 340A is “KVDatastore,” and the name of the API 350A is “strings.”

The configuration 300B includes a plurality of databases 310B, 320B, a datastore 340B, and an API 350B. In an implementation of FIG. 3, the name of the database 310B is “example1,” and the name of the database 320B is “example2.” Further, the name of the datastore 340B is “SomeOtherDatastore,” and the name of the API 350b is “SomeOtherAPI.”

As illustrated in FIG. 3, the configuration 300A is denoted by a configuration “KV” (i.e., key value). Similarly, the configuration 300B is denoted by a configuration “SomeOtherType.” Thus, each configuration defines a same API and a same datastore for each of the databases of that configuration. During initialization, each of the databases requested to be loaded is loaded into the datastore. Because these databases are embedded, interactions are performed via the databases themselves, not via the datastore.

As also illustrated in FIG. 3, the databases 310A, 320A, 330A have different names from the databases 310B, 320B. However, the teachings of the present disclosure are not limited to such an implementation. For example, the configuration 300B can include an additional database named “Database1,” that is, having the same name as the database 310A. Thus, the configuration “SomeOtherType:Database1” could be valid in the same super-configuration 300. In many implementations, this configuration name pair would not reference the same database as the KV:Database1 pair, because database names are only unique per type.

APIs are bound to databases and stores based on an overarching type. Therefore, because the SomeOtherAPI API 350B of the configuration 300B interfaces with the SomeOtherDatastore datastore 340B, the SomeOtherAPI API 350B could not interface with the KVDatastore datastore 340A of the configuration 300A. Rather, for an API to interface with the same datastore as the configuration 300A, an additional configuration (not pictured) could be created with a SomeOtherOtherAPI API and the KVDatastore datastore.

Thus, in super-configuration 300, databases are initialized as a configuration: name pair. In many implementations, the configuration encapsulates both the database load and the API to be registered. Thus, in various implementations, the super-configuration 300 can abstract the database/configuration definition and loading code, whereas the database was hard-coded to a single configuration in the design configuration 200.

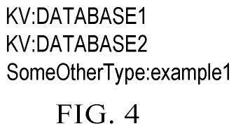

FIG. 4 illustrates a configuration, according to an implementation of the present disclosure. In the example of FIG. 4, the configuration includes three resources. The first resource identifies a configuration of KV and a name of the database 310A, “Database1.” The second resource identifies the configuration of KV and a name of the database 320A, “Database2.” The third resource identifies the configuration of SomeOtherType and a name of the datastore 340B, “SomeOtherDatastore.”

Thus, upon receiving this configuration, the server can determine to pull the KV and SomeOtherType configurations. The server can also determine to load Database1, Database2, and examples from a local disk, if they are present there. If those databases are not on a local disk, then the server can check the artifact registry for these databases and load them therefrom, if available.

For clarity, the example of FIG. 4 loads resources from two configurations, KV and SomeOtherType. However, the teachings of the present disclosure are not limited to loading resources from plural configurations. For example, rather than loading SomeOtherType:example1, the configuration could load “KV:Database3.”

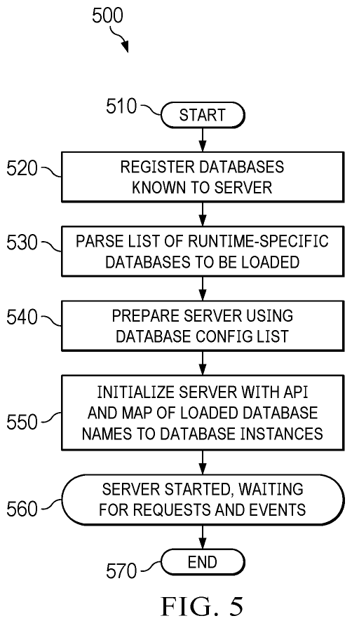

FIG. 5 illustrates a comparative algorithm 500 implemented by a computer and known to the present inventor. FIG. 5 can be understood in connection with the design configuration 200 of FIG. 2.

The algorithm 500 begins at 510 and advances to 520.

In 520, the computer registers the databases that are known to the server. For example, the computer registers the “Database1” database 210, the “Database2” database 220, and the “Database3” database 230. The algorithm 500 then advances to 530.

In 530, the computer parses a list of run-time specific databases to be loaded into the server. The algorithm 500 then advances to 540.

In 540, the computer prepares the server using a database configuration list. The database configuration list can include the parsed, run-time specific databases from 530 that were registered in 520. The algorithm 500 then advances to 550.

In 550, the computer initializes the server with an API and a map of loaded database names to database instances. For example, the server is initialized with the Strings API 250. The server can also be initialized with the KVDatastore datastore 240. The algorithm 500 then advances to 560.

In 560, the server is started. The server then waits for requests and events. The algorithm 500 then advances to 570.

In 570, the algorithm 500 concludes.

As discussed above in connection with FIG. 2, the design configuration 200 is only one configuration and, as such, does not have any configuration-based references.

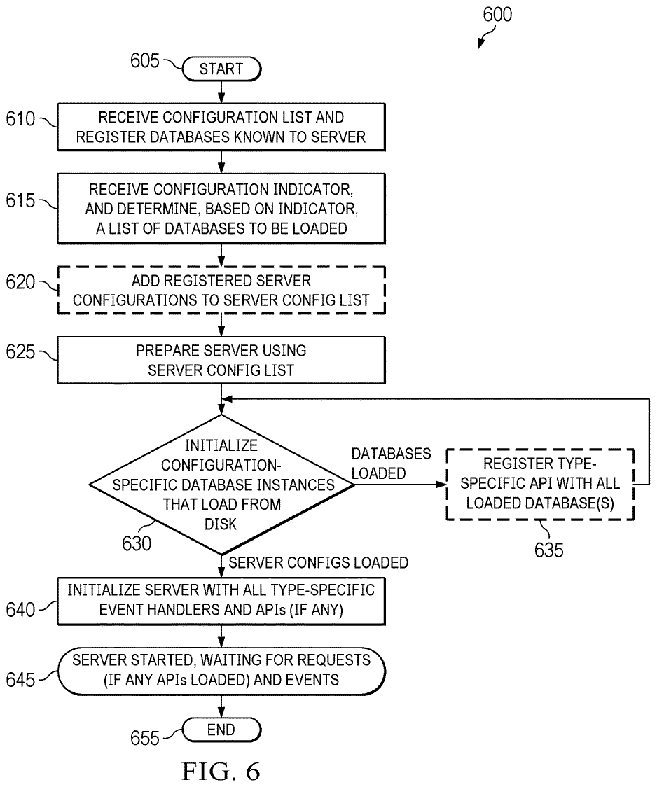

FIG. 6 illustrates an algorithm 600 for a computer to initialize a configuration of a server, according to an implementation of the present disclosure. The algorithm 600 begins at 605 and advances to 610.

In 610, the computer receives a configuration list and registers the databases known to the server. The configuration list includes a plurality of configurations for the server. Thus, each of the configurations can be considered a server type. Each of the plurality of configurations defines at least one respective resource of at least one resource type.

For example, the plurality of configurations can be or include the configuration 300A and the configuration 300B of FIG. 3. The configuration 300A and the configuration 300B each include three types of resources: database, datastore, and API. In various implementations, one or more of the plurality of configurations can include more or fewer types of resources.

The resources of each configuration can be defined by names in the configurations. For example, the configuration 300A defines, for the database resource type, three resources: the “Database1” database 310A, the “Database2” database 320A, and the “Database3” database 330A. The configuration 300A defines, for the datastore resource type, the KVDatastore datastore 340A. The configuration 300A defines, for the API resource type, the Strings API 350A.

The configuration 300B defines, for the database resource type, an “example1” database 310B and an “example2” database 320B. The configuration 300B defines, for the datastore resource type, a “SomeOtherDatastore” datastore 340B. The configuration 300B defines, for the API resource type, a “SomeOtherAPI” API 350B.

Thus, the configuration 300A and the configuration 300B define names of the resources.

In addition, in various implementations, the configurations 300A and/or 300B can define an event handler, such as Gossip. Thus, the event handler can be registered.

The algorithm 600 then advances to 615.

In 615, the computer receives an indication of one of the plurality of configurations. The computer performs a determination of the indicated configuration for the server, at least in part based on the indication.

The algorithm 600 then advances to 620.

In 620, the computer optionally adds a registered server configuration to the server configuration list. For example, the computer can first determine whether there are any unparsed server configurations. If there is an unparsed server configuration, then the computer can determine whether the unparsed server configuration was registered in, for example, 610. If the computer determines the unparsed server configuration was not registered, then the computer can return to determining whether there are any unparsed server configurations. On the other hand, if the computer determines the unparsed server configuration was registered, then the computer adds the unparsed server configuration to the server configuration list. The computer then returns to deciding if there are any remaining unparsed server configurations. If there are no unparsed server configurations, then the algorithm 600 then advances to 625.

In 625, the computer prepares the server using the server configuration list. For example, the server is prepared for the at least one respective resource for the determined configuration. In various implementations, the at least one respective resource includes at least one of a datastore, a database, or an API, as discussed in connection with FIG. 3. The computer can perform the preparing by loading at least one of the datastore, the database, or the application programming interface (API).

The algorithm 600 then advances to 630.

In 630, the computer optionally initializes any configuration-specific database instances that load from a local disk. For example, the computer can first determine whether there are any unloaded server configurations. If there is an unloaded server configuration, then the computer can determine whether there are any unloaded databases for the unloaded server configuration. If there is an unloaded database for the unloaded server configuration, the computer determines whether the configuration-specific database loads from a local disk. If the configuration-specific database does load from a local disk, then the computer initializes an instance of the configuration database. The computer then returns to determining whether there are any remaining databases for the configuration.

Similarly, if the configuration-specific database does not load from a local disk, then, the computer can go out to the artifact registry and attempt to load the database dynamically from there during server initialization. The computer then returns to determining whether there are any remaining databases for the configuration.

Further, if there are no unloaded databases for the unloaded server configuration in 630, then the algorithm 600 then advances to 635.

In 635, the computer registers any configuration-specific API with all loaded databases. The algorithm 600 then returns to 630.

Further, if there are no unloaded server configurations, then the algorithm 600 then advances to 640.

In 640, the computer initializes the server with all configuration-specific event handlers and APIs, if any. The algorithm 600 then advances to 645.

In 645, the server is started. If the server was initialized with a configuration-specific event handler in 640, then the server can handle a received event, at least in part based on the event handler. Further, if the server was initialized with an API in 640, the server can handle any received requests with that API. The algorithm 600 then advances to 650.

The algorithm 600 then advances to 655, in which the algorithm 600 concludes.

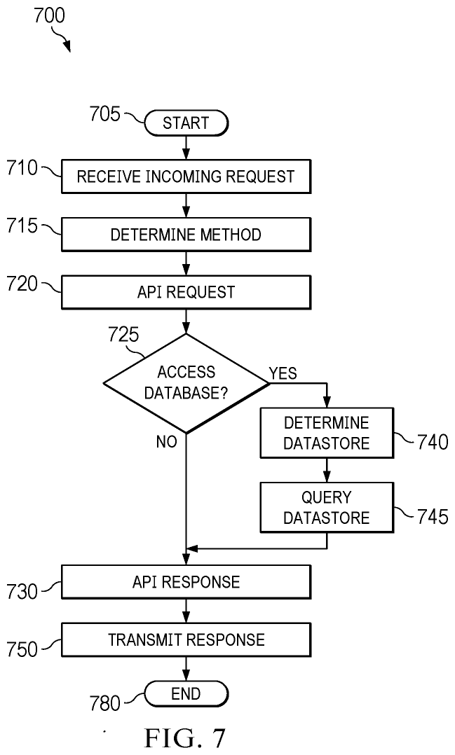

FIG. 7 illustrates an algorithm 700 for a server to handle a database query, according to an implementation of the present disclosure. The algorithm 700 begins at 705 and advances to 710.

In 710, the server receives an incoming gRPC request from a networked computer. In various implementations, the request can include a header that indicates or includes the name of a method signature (path header). Further, the request can include a payload. The payload can indicate or include a protobuf parameter that allows datastore distinction.

Because the request complies with gRPC, the request does not include a command in several implementations. Further, the request can be in the form of binary frames that piggyback on HTTP2, and the http method is always POST in many implementations.

The algorithm 700 then advances to 715.

In 715, the server determines a server method to be called, at least in part based on the request. For example, the server can determine the server method, at least in part based on the name of the method signature indicated or included in the request.

Thus, in various implementations, the server can determine the method, at least in part based on the header of the request. The algorithm 700 then advances to 720.

In 720, the server transmits an API request to the API. The API request can be at least in part based on the method. In various implementations, the API can be served via gRPC and can be done over a Unix Domain Socket or transmission control protocol (TCP). The algorithm 700 then advances to 725.

In 725, the API determines whether to access a database, at least in part based on the method indicated or included in the API request.

If the API determines to access a database, then the algorithm 700 advances to 740. If the API determines not to access a database, then the algorithm 700 performs an operation, at least in part based on the method, and advances to 730.

In 740, the server determines a datastore. For example, the server can determine the datastore, at least in part based on a protobuf indicated or included in the request. The algorithm 700 then advances to 745.

In 745, the server produces a result by querying the datastore determined in 740, at least in part based on the payload in the request. For example, the server can fetch data from the datastore, if the payload indicates the data to be fetched. The algorithm 700 then advances to 730.

In 730, the API returns a result of the operation to the server. This result is structured in a conventional manner that would be understood by one having ordinary skill in the art. The algorithm 700 then advances to 750.

In various implementations, the API request in 720 and the API response in 730 can be specific to a configuration in the super-configuration and follow protocol buffers (protobufs) defined for that API. Internally, they could be database lookups, they could load objects off disk or memory, and/or they could invoke some other service to do something. In this regard, the functionality is up to the API. The only contract between the gRPC framework and the internal API can be the protobuf definition(s) that are registered.

In 750, the server transmits a response to the request. For example, the response can include or indicate the API response. The algorithm 700 then advances to 780.

In 780, the algorithm 700 concludes.

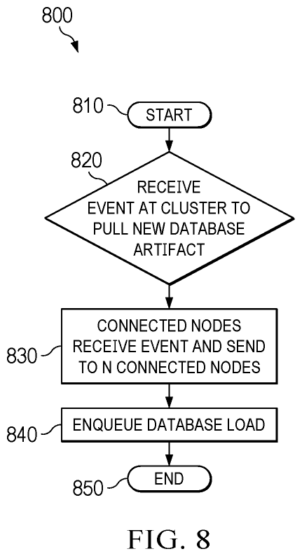

FIG. 8 illustrates an algorithm 800 for a server to handle a gossip request, according to an implementation of the present disclosure. The algorithm 800 begins at 810 and progresses to 820.

In 820, the server receives an event at the cluster to pull a new database artifact. In several implementations, the request identifies the database artifact by database name and version. The algorithm 800 then advances to 830.

In 830, a connected node can receive the event and send the event to N connected nodes. For example, if the event is a Gossip event, then the event can be handled by a Gossip event handler resource. Thus, the connected node can “gossip” with the other nodes. The algorithm 800 then advances to 840.

In 840, loading of the database is enqueued at the various nodes. The algorithm 800 then advances to 850.

In 850, the algorithm 800 concludes.

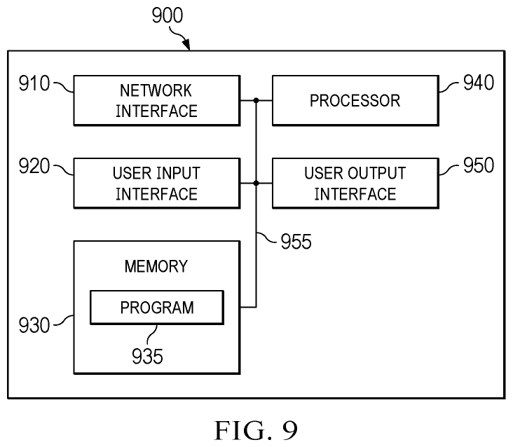

FIG. 9 illustrates a computing device 900, according to an implementation of the present disclosure. The conceptual architecture 100, the super-configuration 300, and/or the server can be implemented with a computing device 900.

The computing device 900 can include a network interface 910, a user input interface 920, a memory 930, a program 935, a processor 940, a user output interface 950, and a bus 955.

Although illustrated within a single housing, the computing device 900 can be distributed across plural housings or sub-systems that cooperate in executing program instructions. In some implementations, the computing device 900 can include one or more blade server devices, standalone server devices, personal computers (including laptop computers and tablet computers), routers, hubs, switches, bridges, firewall devices, intrusion detection devices, mainframe computers, network-attached storage devices, smartphones and other mobile telephones, and other computing devices. Although the computing device executes the Windows OS, macOS, or Linux in many implementations, the hardware can be configured according to a Symmetric Multi-Processing (SMP) architecture or a Non-Uniform Memory Access (NUMA) architecture.

The network interface 910 provides one or more communication connections and/or one or more devices that allow for communication between the computing device 900 and other computing systems (not shown) over a communication network, collection of networks (not shown), or the air, to support the server support for multiple types of embedded datastores, outlined herein. The network interface 910 can communicate using various networks (including both internal and external networks) such as near-field communications (NFC), Wi-Fi™, Bluetooth, Ethernet, cellular (e.g., 3G, 4G, 5G), white space, 802.11x, satellite, LTE, GSM/HSPA, CDMA/EVDO, DSRC, CAN, GPS, facsimile, or any other wired or wireless interface. Other interfaces can include physical ports (e.g., Ethernet, USB, HDMI, etc.), interfaces for wired and wireless internal subsystems, and the like. Similarly, nodes and user equipment (e.g., mobile devices) of the system can also include suitable interfaces for receiving, transmitting, and/or otherwise communicating data or information in a network environment.

The user input interface 920 can receive one or more inputs from a human. The user input interface 920 can be or include a mouse, a touchpad, a keyboard, a touchscreen, a trackball, a camera, a microphone, a joystick, a game controller, a scanner, and/or any other input device.

The memory 930, also termed a “storage,” can include or be one or more computer-readable storage media readable by the processor 940 and that store software. The memory 930 can be implemented as one storage device or across multiple co-located or distributed storage devices or sub-systems. The memory 930 can include additional elements, such as a controller, that communicate with the processor 940. The memory 930 can also include storage devices and/or sub-systems on which data and/or instructions are stored. The computing device 900 can access one or more storage resources to access information to carry out any of the processes indicated in this disclosure and, in particular, FIGS. 1 and 5-8. In various implementations, the memory 930 stores the program 935 to execute at least a portion of the algorithms illustrated in FIGS. 1 and 5-8. Further, the program 935, when executed by the computing device 900 generally and/or the processor 940 specifically, can direct, among other functions, performance of the server support for multiple types of embedded datastores, as described herein. Thus, the processor 940 is an example of a means for performing the algorithms detailed in FIGS. 1 and 5-8.

The memory 930 can be or include a read-only memory (ROM), a programmable ROM (PROM), an erasable PROM (EPROM), an electrically erasable PROM (EEPROM), a random-access memory (RAM), a dynamic RAM (DRAM), a static RAM (SRAM), a field programmable gate array (FPGA), a hard drive, a cache memory, a flash memory, a removable disk, or a tape reel. The memory 930 can be or include resistive RAM (RRAM) or a magneto-resistive RAM (MRAM). The information being tracked, sent, received, or stored in the computing device can be provided in any database, register, table, cache, queue, control list, or storage structure, based on particular implementations, all of which could be referenced in any suitable timeframe.

The processor 940 (e.g., a processing unit) can be or include one or more hardware processors and/or other circuitry that retrieve and execute software, especially the program 935, from the memory 930. The processor 940 can be implemented within one processing device, chip, or package and can also be distributed across multiple processing devices, chips, packages, or sub-systems that cooperate. In some implementations, the processor 940 is or includes a Graphics Processing Unit (GPU) or neural processing unit (NPU).

The processor 940 can have any register size, such as a 32-bit register or a 64-bit register, among others. The processor 940 can include multiple cores. Implementations of the processor 940 are not limited to any particular number of threads. The processor 940 can be fabricated by any process technology, such as 14 nm process technology.

The user output interface 950 outputs information to a human user. The user output interface 950 can be or include a display (e.g., a screen), a touchscreen, speakers, a printer, or a haptic feedback unit. In many implementations, the user output interface 950 can be combined with the user input interface 920. For example, some such implementations include a touchscreen, a headset including headphones and a microphone, or a joystick with haptic feedback.

In implementations including multiple computing devices, a server of the system or, in a serverless implementation, a peer can use one or more communications networks that facilitate communication among the computing devices to achieve the server support for multiple types of embedded datastores, as outlined herein. For example, the one or more communications networks can include or be a local area network (LAN) or wide area network (WAN) that facilitate communication among the computing devices. One or more direct communication links can be included between the computing devices. In addition, in some cases, the computing devices can be installed at geographically distributed locations. In other cases, the multiple computing devices can be installed at one geographic location, such as a server farm or an office.

As used herein, the terms “storage media” or “computer-readable storage media” can refer to non-transitory storage media, such as non-limiting examples of a hard drive, a memory chip, an ASIC, and cache memory, and to transitory storage media, such as carrier waves or propagating signals.

Aspects of the system can be implemented in various manners, e.g., as a method, a system, a computer program product, or one or more computer-readable storage media. Accordingly, aspects of the present disclosure can take the form of a hardware implementation, a software implementation (including firmware, resident software, or micro-code) or an implementation combining software and hardware aspects that can generally be referred to herein as a “module” or a “system.” Functions described in this disclosure can be implemented as an algorithm executed by one or more hardware processing units, e.g., the processor 940. In various embodiments, different operations and portions of the operations of the algorithms described can be performed by different processing units. In some implementations, the operations can be achieved by reciprocating software in any of the conceptual architecture 100, the super-configuration 300, and/or the server. The program 935 can be implemented using reciprocating software. Furthermore, aspects of the present disclosure can take the form of a computer program product embodied in one or more computer-readable media having computer-readable program code embodied, e.g., encoded or stored, thereon. In various implementations, such a computer program can, for example, be downloaded (or updated) to existing devices and systems or be stored upon manufacture of these devices and systems.

Any suitable permutation can be applied to a physical implementation, including the design of the communications network in which the system is implemented. In one embodiment, the bus 955 can share hardware resources with the memory 930 and the processor 940. In this alternative implementation, the computing device 900 can be provided with separate hardware resources including one or more processors and memory elements.

In example implementations, various other components of the computing device 900 can be installed in different physical areas or can be installed as single units.

The computing device 900 can be configured to facilitate communication with machine devices (e.g., vehicle sensors, instruments, electronic control units (ECUs), embedded devices, actuators, displays, etc.) through the bus 955. Other suitable communication interfaces can also be provided for an Internet Protocol (IP) network, a user datagram protocol (UDP) network, or any other suitable protocol or communication architecture enabling network communication with machine devices.

The innovations in this detailed description can be implemented in a multitude of different ways, for example, as defined and covered by the claims and/or select examples. In the description, reference is made to the drawings where like reference numerals can indicate identical or functionally similar elements. Elements illustrated in the drawings are not necessarily drawn to scale. Additionally, certain implementations can include more elements than illustrated in a drawing and/or a subset of the elements illustrated in a drawing. Further, some implementations can incorporate a suitable combination of features from two or more drawings.

The disclosure describes various illustrative implementations and examples for implementing the features and functionality of the present disclosure. The components, arrangements, and/or features are described in connection with various implementations and are merely examples to simplify the present disclosure and are not intended to be limiting. In the development of actual implementations, implementation-specific decisions can be made to achieve specific goals, including compliance with system, business, and/or legal constraints, which can vary from one implementation to another. Additionally, while such a development effort might be complex and time-consuming, it would be a routine undertaking for those of ordinary skill in the art having the benefit of this disclosure.

The systems, methods and devices of this disclosure have several innovative aspects, no one of which is solely responsible for the attributes disclosed herein. Some objects or advantages might not be achieved by implementations described herein. Thus, for example, certain implementations can operate in a manner that achieves or optimizes one advantage or group of advantages as taught herein and not other objects or advantages as taught or suggested herein.

In one example implementation, electrical circuits of the drawings can be implemented on a board of an associated electronic device. The board can be a general circuit board that can hold various components of the internal electronic system of the electronic device and, further, provide connectors for other peripherals. More specifically, the board can provide the electrical connections by which other components of the system can communicate electrically. Any processors (inclusive of digital signal processors, microprocessors, supporting chipsets, etc.) and computer-readable, non-transitory memory elements can be coupled to the board based on configurations, processing demands, and computer designs. Other components such as external storage, additional sensors, controllers for audio/video display, and peripheral devices can be attached to the board as plug-in cards, via cables, or integrated into the board itself. In various implementations, the functionalities described herein can be implemented in emulation form as software or firmware running within one or more configurable (e.g., programmable) elements arranged in a structure that supports these functions. A non-transitory, computer-readable storage medium can include instructions to allow one or more processors to carry out the emulation.

In another example implementation, the electrical circuits of the drawings can be implemented as stand-alone modules (e.g., a device with associated components and circuitry configured to perform a specific application or function) or implemented as plug-in modules into application specific hardware of electronic devices. Implementations of the present disclosure can be readily included in a system-on-chip (SOC) package. An SOC represents an integrated circuit (IC) that integrates components of a computer or other electronic system into one chip. The SOC can contain digital, analog, mixed-signal, and often radio frequency functions on one chip substrate. Other implementations can include a multi-chip-module (MCM), with a plurality of separate ICs located within one electronic package and that interact through the electronic package. In various other implementations, the processors can be implemented in one or more silicon cores in Application Specific Integrated Circuits (ASICs), Field Programmable Gate Arrays (FPGAs), programmable array logic (PAL), generic array logic (GAL), and other semiconductor chips.

The specifications, dimensions, and relationships outlined herein (e.g., the number of processors and logic operations) have been offered for non-limiting purposes of example and teaching. For example, various modifications and changes can be made to the arrangements of components. The description and drawings are, accordingly, to be regarded in an illustrative sense, not in a restrictive sense.

The numerous examples provided herein described interaction in terms of two, three, or more electrical components for purposes of clarity and example. The system can be consolidated in any manner. Along similar design alternatives, the illustrated components, modules, and elements of the drawings can be combined in various possible configurations within the scope of this disclosure. In certain cases, one or more of the functionalities of a given set of flows might be more clearly described by referencing a limited number of electrical elements. The electrical circuits of the drawings are readily scalable and can accommodate many components, as well as more complicated/sophisticated arrangements and configurations. Accordingly, the provided examples do not limit the scope or inhibit the teachings of the electrical circuits as potentially applied to a myriad of other architectures.

In this disclosure, references to various features (e.g., elements, structures, modules, components, steps, operations, characteristics, etc.) included in “one implementation,” “example implementation,” “an implementation,” “another implementation,” “some implementations,” “various implementations,” “other implementations,” “alternative implementation,” and the like are intended to mean that any such features can be included in one or more implementations of the present disclosure and might or might not necessarily be combined in the same implementations. Some operations can be deleted or omitted where appropriate, or these operations can be modified or changed considerably. In addition, the timing of these operations can be altered considerably. The preceding operational flows have been offered for purposes of example and discussion. Implementations described herein provide flexibility in that any suitable arrangements, chronologies, configurations, and timing mechanisms can be provided.

### Examples

In Example M1, a method is to initialize a server. The method includes receiving a plurality of configurations for the server, each of the plurality of configurations defining at least an application programming interface (API); receiving an indication of a first configuration of the plurality of configurations; performing a determination of the API, at least in part based on the indication; and preparing the server for the API, at least in part based on the determination.

Example M2 is the method of Example M1, further comprising: registering an event handler, wherein the first configuration indicates the event handler; and initializing the server with the event handler.

Example M3 is the method of Example M2, wherein the server receives an event, and the server is to handle the event, at least in part based on the event handler.

Example M4 is the method of any of Examples M1-M3, further comprising: determining a database or a datastore, at least in part based on the indication; and preparing the server for the database or the datastore, at least in part based on the determining.

Example M5 is the method of any of Examples M1-M4, wherein the preparing is performed by loading the API into the server.

Example M6 is the method of any of Examples M1-M5, wherein a second configuration of the plurality of configurations defines a name of a database for the second configuration.

Example M7 is the method of any of Examples M1-M6, wherein the server is to receive a request indicating a method, to determine the method, at least in part based on the request, and to perform an operation, at least in part based on the method.

In Example A1, a system includes a memory that stores at least one instruction; and at least one processor configured, with the memory, to cause the system to at least receive a plurality of configurations for a server, each of the plurality of configurations defining at least an application programming interface (API); receive an indication of a first configuration of the plurality of configurations; perform a determination of the API, at least in part based on the indication; and perform a preparation of the server for the API, at least in part based on the determination.

Example A2 is the system of Example A1, wherein the at least one processor is further configured to cause the system to at least register an event handler, wherein the first configuration indicates the event handler, and initialize the server with the event handler.

Example A3 is the system of Example A2, wherein the server is to receive an event, and the server is to handle the event, at least in part based on the event handler.

Example A4 is the system of any of Examples A1-A3, wherein the at least one processor is further configured, with the memory, to cause the system to at least perform a determination of a database or a datastore, at least in part based on the indication, and to perform a preparation of the server for the database or the datastore, at least in part based on the determination of the database or the datastore.

Example A5 is the system of any of Examples A1-A4, wherein the preparation is performed by loading the API into the server.

Example A6 is the system of any of Examples A1-A5, wherein a second configuration of the plurality of configurations defines a name of a database for the second configuration.

Example A7 is the system of any of Examples A1-A6, wherein the server is to receive a request indicating a method, to determine the method, at least in part based on the request, and to perform an operation, at least in part based on the method.

In Example C1, a computer-readable medium is encoded with a computer program that, when executed by a system including at least one processor, causes the system to perform operations. The operations include receiving a plurality of configurations for a server, each of the plurality of configurations defining at least an application programming interface (API); receiving an indication of a first configuration of the plurality of configurations; performing a determination of the API, at least in part based on the indication; and preparing the server for the API, at least in part based on the determination.

Example C2 is the medium of Example C1, the operations further comprising: registering an event handler, wherein the first configuration indicates the event handler; and initializing the server with the event handler.

Example C3 is the medium of Example C2, wherein the server is to receive an event, and the server is to handle the event, at least in part based on the event handler.

Example C4 is the medium of any of Examples C1-C3, the operations further comprising: determining a database or a datastore, at least in part based on the indication; and preparing the server for the database or the datastore, at least in part based on the determining.

Example C5 is the medium of any of Examples C1-C4, wherein the preparing is performed by loading the API into the server.

Example C6 is the medium of any of Examples C1-C5, wherein a second configuration of the plurality of configurations defines a name of a database for the second configuration.

Example C7 is the medium of any of Examples C1-C6, wherein the server is to receive a request indicating a method, to determine the method, at least in part based on the request, and to perform an operation, at least in part based on the method.

In Example F1, an apparatus includes receiving means for receiving a plurality of configurations for the server, each of the plurality of configurations defining at least an application programming interface (API), and for receiving an indication of a first configuration of the plurality of configurations; and processing means for performing a determination of the API, at least in part based on the indication, and for preparing the server for the API, at least in part based on the determination.

Example F2 is the apparatus of Example F1, wherein the processing means registers an event handler, the first configuration indicates the event handler, and the processing means initializes the server with the event handler.

Example F3 is the apparatus of Example F2, wherein the server is to receive an event, and the server is to handle the event, at least in part based on the event handler.

Example F4 is the apparatus of any of Examples F1-F3, wherein the processing means performs a determination of a database or a datastore, at least in part based on the indication, and the processing means performs a preparation of the server for the database or the datastore, at least in part based on the determination of the database or the datastore.

Example F5 is the apparatus of any of Examples F1-F4, wherein the preparation is performed by loading the API into the server.

Example F6 is the apparatus of any of Examples F1-F5, wherein a second configuration of the plurality of configurations defines a name of a database for the second configuration.

Example F7 is the apparatus of any of Examples F1-F6, wherein the server is to receive a request indicating a method, to determine the method, at least in part based on the request, and to perform an operation, at least in part based on the method.

I claim:

1. A method to initialize a server, the method comprising:
receiving a plurality of configurations for the server, each of the plurality of configurations defining at least an application programming interface (API);
receiving an indication of a first configuration of the plurality of configurations;
performing a determination of the API, at least in part based on the indication; and
preparing the server for the API, at least in part based on the determination.

2. The method of claim 1, further comprising:
registering an event handler, wherein the first configuration indicates the event handler; and
initializing the server with the event handler.

3. The method of claim 2, wherein the server receives an event, and the server is to handle the event, at least in part based on the event handler.

4. The method of claim 1, further comprising:
determining a database or a datastore, at least in part based on the indication; and
preparing the server for the database or the datastore, at least in part based on the determining.

5. The method of claim 1, wherein the preparing is performed by loading the API.

6. The method of claim 1, wherein a second configuration of the plurality of configurations defines a name of a database for the second configuration.

7. The method of claim 1, wherein the server is to receive a request indicating a method, to determine the method, at least in part based on the request, and to perform an operation, at least in part based on the method.

8. A system, comprising:
a memory that stores at least one instruction; and
at least one processor configured, with the memory, to cause the system to at least
receive a plurality of configurations for a server, each of the plurality of configurations defining at least an application programming interface (API);
receive an indication of a first configuration of the plurality of configurations;
perform a determination of the API, at least in part based on the indication; and
perform a preparation of the server for the API, at least in part based on the determination.

9. The system of claim 8, wherein the at least one processor is further configured to cause the system to at least
register an event handler, wherein the first configuration indicates the event handler, and
initialize the server with the event handler.

10. The system of claim 9, wherein the server is to receive an event, and the server is to handle the event, at least in part based on the event handler.

11. The system of claim 8, wherein the at least one processor is further configured, with the memory, to cause the system to at least perform a determination of a database or a datastore, at least in part based on the indication, and to prepare the server for the database or the datastore, at least in part based on the determination of the database or the datastore.

12. The system of claim 8, wherein the preparation is performed by loading the API.

13. The system of claim 8, wherein a second configuration of the plurality of configurations defines a name of a database for the second configuration.

14. The system of claim 8, wherein the server is to receive a request indicating a method, to determine the method, at least in part based on the request, and to perform an operation, at least in part based on the method.

15. A computer-readable medium encoded with a computer program that, when executed by a system including at least one processor, causes the system to perform operations comprising:
receiving a plurality of configurations for a server, each of the plurality of configurations defining at least an application programming interface (API);
receiving an indication of a first configuration of the plurality of configurations;
performing a determination of the API, at least in part based on the indication; and
preparing the server for the API, at least in part based on the determination.

16. The medium of claim 15, the operations further comprising:
registering an event handler, wherein the first configuration indicates the event handler; and
initializing the server with the event handler.

17. The medium of claim 16, wherein the server is to receive an event, and the server is to handle the event, at least in part based on the event handler.

18. The medium of claim 15, the operations further comprising:
determining a database or a datastore, at least in part based on the indication; and
preparing the server for the database or the datastore, at least in part based on the determining.

19. The medium of claim 15, wherein the preparing is performed by loading the API.

20. The medium of claim 15, wherein a second configuration of the plurality of configurations defines a name of a database for the second configuration.
